(19) United States
(12) Patent Application Publication
(10) Pub. No.: US 2026/0161485 A1
(43) Pub. Date: Jun. 11, 2026

(54) SYSTEM AND METHOD FOR GENERATIVE AI CODE MODERNIZATION AND INTEGRATION

(71) Applicant: KPMG LLP, New York, NY (US)

(72) Inventors: Thilina Gunarathne, Knoxville, TN (US); Dan Hailegiorgis, Minneapolis, MN (US); Kevin Martelli, Media, PA (US); Christopher Panneck, Dallas, TX (US); Milinda Pathirage, Knoxville, TN (US); Ashok Riwaria, Austin, TX (US)

(21) Appl. No.: 19/179,597

(22) Filed: Apr. 15, 2025

Related U.S. Application Data
(60) Provisional application No. 63/634,336, filed on Apr. 15, 2024.

(51) Int. Cl. G06F 9/54; G06F 11/3604

(52) U.S. Cl. CPC G06F 9/541; G06F 11/3608

(57) ABSTRACT

The invention relates to computer-implemented systems and methods for implementing Generative AI code modernization and integration. An embodiment of the present invention is directed to a code modernization tool or platform that efficiently modernize code to meet various business and technology objectives. An embodiment of the present invention is directed to assisting organizations modernize from legacy code and technologies to modern, maintainable code through Generative AI.

### CROSS-REFERENCE TO RELATED APPLICATIONS

The application claims priority to U.S. Provisional Application 63/634,336 (Attorney Docket No. 055089.0000127), filed Apr. 15, 2024, the contents of which are incorporated by reference herein in their entirety.

### FIELD OF THE INVENTION

The present invention relates to systems and methods for implementing a Generative Artificial Intelligence (GenAI) code platform for modernization and integration to accelerate and facilitate a client's application modernization, cloud journey, reduce risk and improve delivery quality.

### BACKGROUND

Generally, modernization may represent the process of transitioning an organization's applications, processes and data management to a modern technology stack on cloud or other environment. Modernization oftentimes involves a deep analysis of applications and then a build of an updated system towards improved efficiencies and reduced costs.

Some enterprise clients have been working with the same technology for years, if not decades. In an effort to modernize, clients seek to address migration in a piecemeal manner which leads to inefficiencies down the road. In other scenarios, clients may continue to work with outdated frameworks unsure how to approach modernization. Other needs may involve retiring certain systems. In addition, the modernization process may involve code migration that has additional complexities and challenges. Current solutions fail to address compatibility issues, ensure data integrity and properly manage dependencies, which lead to business disruptions and other inefficiencies.

Enterprise clients may have systems that use and/or rely on custom developed applications. To address immediate needs, these clients may have integrated applications without a comprehensive plan in mind. This leads to disjointed applications that lack cooperation and consistency. Moreover, code is generally developed as business and product needs progress, without a clear modernization strategy in place. Inevitably, critical applications and underlying code that perform essential functions are in need of modernization and improved efficiencies. Other challenges facing enterprise clients include lack of skill or bandwidth to perform the modernization.

It would be desirable, therefore, to have a system and method that could overcome the foregoing disadvantages.

### SUMMARY

According to one embodiment, the invention relates to a computer-implemented system that implements a GenAI code modernization and integration platform. The system comprises: an input interface that communicates with one or more data pipelines; a database that stores and manages data from the one or more data pipelines; and a computer processor coupled to the input interface and the database and further programmed to perform the steps of: creating an inventory of application programming interfaces for a legacy environment; identifying one or more custom connectors to achieve parity with the inventory of application programming interfaces; assessing a current state of observability to identify one or more gaps and enhancements needed; defining a target architecture design for a deployment model wherein the deployment model relates to an API deployment with generative artificial intelligence (GenAI) based code generation, a connector deployment and a policy alternative deployment and wherein the deployment model applies a GenAI model with large language model (LLM) prompts for the one or more custom connectors; applying the GenAI model to convert a set of legacy application programming interfaces to a set of modernized controllers; developing scripts and pipelines to manage a deployment of the set of modernized controllers; performing a set of tests to validate functional requirements, wherein the set of tests comprises integration testing and user acceptance testing; and providing, via a user interface, a code translation and an activity status associated with the deployment.

According to another embodiment, the invention relates to a computer-implemented method that implements a GenAI code modernization and integration platform. The method comprises the steps of: creating, via an input interface, an inventory of application programming interfaces for a legacy environment; identifying, via a computer processor, one or more custom connectors to achieve parity with the inventory of application programming interfaces; assessing, via the computer processor, a current state of observability to identify one or more gaps and enhancements needed; defining, via the computer processor, a target architecture design for a deployment model wherein the deployment model relates to an API deployment with generative artificial intelligence (GenAI) based code generation, a connector deployment and a policy alternative deployment and wherein the deployment model applies a GenAI model with large language model (LLM) prompts for the one or more custom connectors; applying, via the computer processor, the GenAI model to convert a set of legacy application programming interfaces to a set of modernized controllers; developing, via the computer processor, scripts and pipelines to manage a deployment of the set of modernized controllers; performing, via the computer processor, a set of tests to validate functional requirements, wherein the set of tests comprises integration testing and user acceptance testing; and providing, via a user interface, a code translation and an activity status associated with the deployment.

Some enterprise clients may not have the resources or knowledge to accurately and comprehensively identify all the applications and relevant code that exist, relevant dependencies, subset of users, and which components need to be modernized. Lack of data, insights and development knowledge are hinderances to a successful modernization/migration. Accordingly, an embodiment of the present invention recognizes that proper analysis needs to occur prior to the modernization process. An embodiment of the present invention may support integration with an AI Intelligent Assistant that allows users to interact with the system by requesting clarification, making changes and seeking validation. This further expedites the process towards efficient use of resources.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary diagram, according to an embodiment of the present invention.

FIG. 2 is an exemplary illustration, according to an embodiment of the present invention.

FIG. 3 is an exemplary illustration, according to an embodiment of the present invention.

FIG. 4 is an exemplary flowchart, according to an embodiment of the present invention.

FIG. 5 is an exemplary flowchart, according to an embodiment of the present invention.

FIG. 6 is an exemplary diagram, according to an embodiment of the present invention.

FIG. 7 is an exemplary diagram, according to an embodiment of the present invention.

FIG. 8 illustrates a user interface, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to a method and system for implementing a generative artificial intelligence (GenAI) Code platform for modernization and integration. An embodiment of the present invention may be integrated with an Application Modernization and Migration Tool to accelerate a client's cloud journey, reduce risk and improve delivery quality, as described in U.S. patent application Ser. No. 19/052,630 (Attorney Docket No. 055089.0000143), entitled “System and Method for Implementing Application Modernization and Migration,” filed Feb. 13, 2025, which claims priority to U.S. Provisional Application 63/552,954 (Attorney Docket No. 055089.0000125), filed Feb. 13, 2024, the contents of which are incorporated by reference herein in their entirety. An embodiment of the present invention may provide an integrated AI driven approach that is based on a business value-approach engineered for scalability, security and speed. Cloud solutions may include: cloud/data strategy and architecture; cloud modernization and migration; cloud emerging technology; hybrid/multi cloud enablement; modern data fabric and AI; cloud/data management and optimization; cloud/data security and compliance; cloud resiliency; cloud development; advanced technology integration and cloud managed services.

An embodiment of the present invention is directed to various modernization offerings including a wide range of technology solutions and accelerators for businesses to modernize their IT landscape and stay ahead in today's rapidly changing technological environment. Modernization offerings may include services relating to legacy java/. net; mainframe; database; data and analytics pipelines; SAS and other models. An embodiment of the present invention supports repeatability and scalability.

An embodiment of the present invention recognizes that modernizing an IT landscape updates and improves an organization's technology infrastructure, systems, and practices so they are capable of meeting current and future needs of the business.

An embodiment of the present invention is directed to transforming outdated technology and applications into modern solutions to facilitate and improve integration with new technologies and adapt to future demands.

According to an embodiment of the present invention, modernization may include: modernizing legacy applications; leveraging artificial intelligence and machine learning; embracing agile and DevOps methodologies and improving IT infrastructure by adopting cloud services.

Leveraging AI to modernize realizes significant benefits and advantages including reduced development time, reduced expenses and resources and faster migration and modernization. An embodiment of the present invention seeks to accelerate development cycles with a platform that supports a combination of GenAI assisted application modernization accelerators.

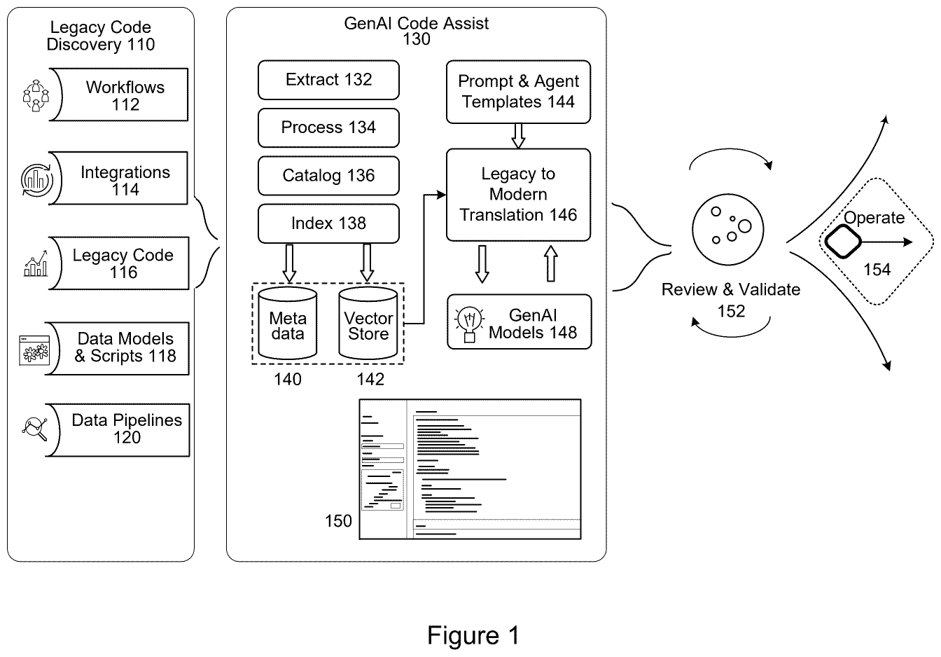

FIG. 1 is an exemplary diagram, according to an embodiment of the present invention. GenAI Code Assist may represent a translation and modernization tool or platform that efficiently modernizes code to meet various business and technology objectives. An embodiment of the present invention is directed to assisting organizations modernize legacy code and technologies to modern, maintainable code through Generative AI.

As shown in FIG. 1, Legacy Code Discovery 110 may be applied to assess a current state of workloads to decompose legacy workloads, extract logic, determine a potential modernization pathway. Legacy Code Discovery 110 may apply to: Workflows 112, Integrations 114, Legacy Code 116, Data Models and Scripts 118 as well as Data Pipelines 120.

GenAI Code Assist 130 may process, catalog, and index code artifacts, documentation, and other relevant information to enrich large language model (LLM) prompts as necessary to achieve desired translation and modernization goals. As shown in FIG. 1, GenAI Code Assist 130 may perform pre-processing actions including: Extract 132, Process 134, Catalog 136 and Index 138 code and other related data to organize the legacy code and logic for effective code modernization. The code and related data may be stored and managed in storage devices including Metadata Store 140 and Vector Store 142.

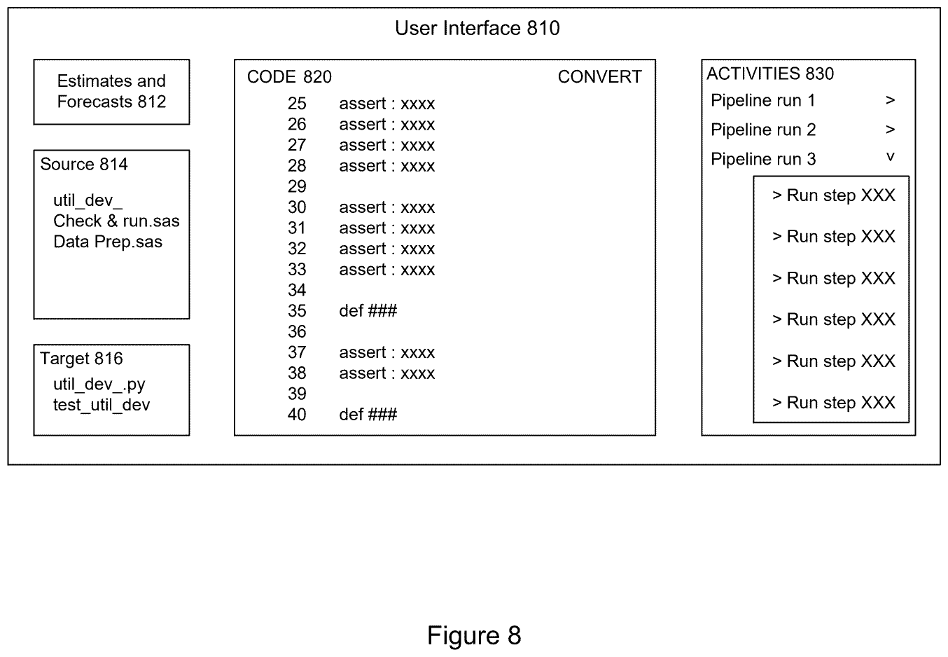

Prompts and agent templates 144 may be applied to perform a legacy to modern translation 146 through the use of GenAI Models 148 that may be fine tuned through output formatting and validation mechanisms to improve the predictability and accuracy of code generation. User Interface 150 enable users to view and manage code migration/modernization progress. Additional details of User Interface 150 are provided in FIG. 8 below.

An embodiment of the present invention may apply a review and validate process 152 where automated agent based test generation, test data generation, test execution, defect remediation as well as expert review, refactor (or restructure exiting code to improve its structure, readability and maintainability), and test processes may be applied to validated generated code. Operate 154 may leverage industry leading development, security and operations (DevSecOps) practices to operate at scale with confidence.

According to an embodiment of the present invention, GenAI Code Assist 130 may combine Generative AI with subject matter expertise to overcome common limitations and achieve better results that align with specific business needs more efficiently.

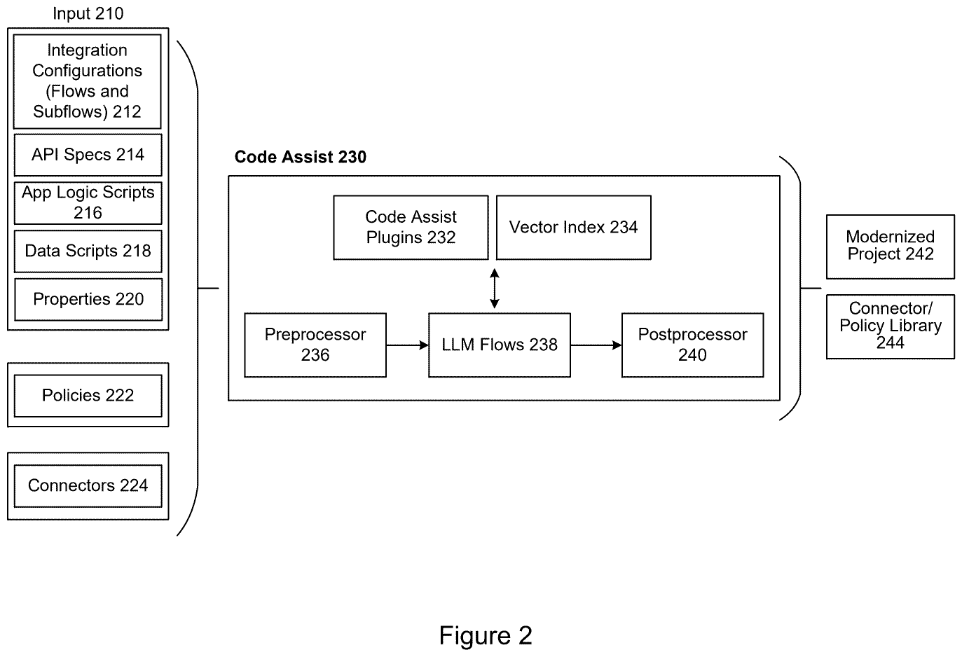

FIG. 2 is an exemplary illustration, according to an embodiment of the present invention. Code Assist 230 may receive Inputs 210 including Integration Configurations 212, API specifications 214, Application Logic Scripts 216, Data Scripts 218, and Properties 220. Inputs 210 may also include: Policies 222 and Connectors 224.

Code Assist 230 may include Code Assist Plugins 232 that perform use case specific processing, Vector Index 234 that stores the extracted information to be used during code generation, Preprocessor 236 that executes pre-processing logic, LLM Flows 238 that use an agent approach to execute a series of LLM commands and Postprocessor 240 that validates, tests and remediates the generated code. In this example, Code Assist 230 may be applied to facilitate modernization and/or integration of code written in a specific platform into another platform. This may involve converting a first set of configuration files, components and flows into a second set of configuration and application components.

Outputs may communicate with Modernized Project 242 and Connector/Policy Library 244. These outputs may be used to facilitate and streamline translation and integration.

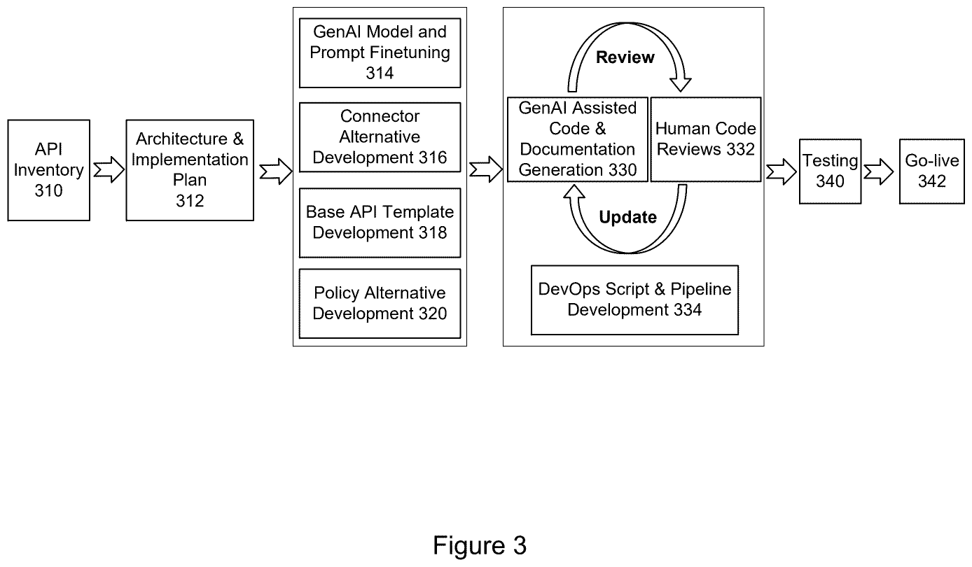

FIG. 3 is an exemplary illustration, according to an embodiment of the present invention. An embodiment of the present invention is directed to analyzing existing APIs, identifying potential connector development needs, and service level objectives (SLOs) that APIs may be required to meet. SLOs may represent specific measurable targets for performance or reliability of a service. The innovative approach defines high-level architecture, base template requirements, development roadmap, test strategy, and GenAI model changes for migrating APIs to a set of services or framework for building applications. In this example, the APIs may support an integration platform and API management solution that connects different applications, data sources and APIs offering features for API management, data transformation and integration flows.

As shown in FIG. 3, API inventory 310 may be used to generate an Architecture and Implementation Plan 312. Processing may include: GenAI Model and Prompt Finetuning 314, Connector Alternative Development 316, Base API Template Development 318, and Policy Alternative Development 320.

An embodiment of the present invention may apply GenAI Assisted code and documentation generation 330 which may be reviewed by Human Code Reviewers 332 who may then update through DevOps Script and Pipeline Development 334.

Testing may be applied at 340 with Go-Live at 342.

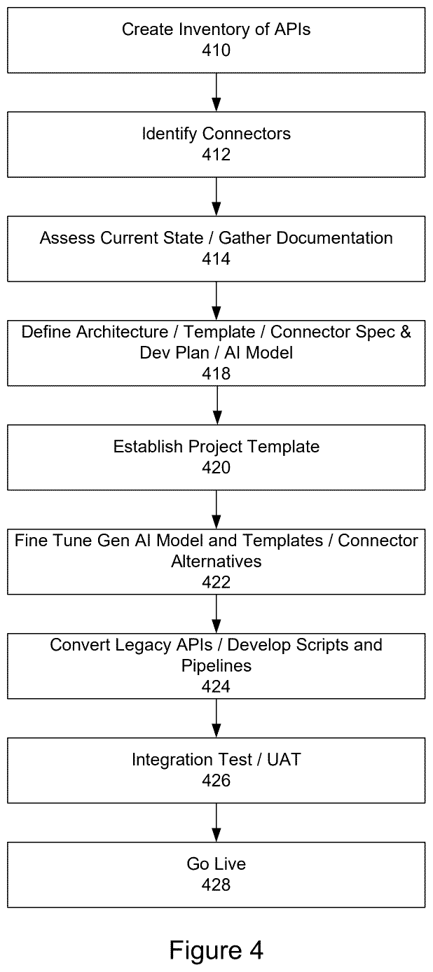

FIG. 4 is an exemplary flowchart, according to an embodiment of the present invention. As shown in FIG. 4, a Discovery and Gap Analysis may be performed. This may involve creating an inventory of APIs at step 410. The inventory of APIs may include: usage of connectors, service level objectives, security requirements, and any specific capability APIs may utilize. Step 412 may identify custom connectors or other capability development needed to achieve feature parity with legacy APIs. Step 414 may assess the current state observability setup to identify any gaps and/or enhancements. In addition, relevant documentation may be gathered around infrastructure and DevOps capabilities, best practices, and/or guidelines new developments should follow.

Step 418 may define a high-level architecture including a deployment model. In addition, a project template may be defined that follows best practices and non-functional requirements. Connector alternative specifications and development plan including prioritization for connector alternatives may be defined. Step 418 may also define a GenAI model and prompt finetuning to address unique scenarios and custom connectors.

Step 420 may establish a project template, incorporating required logging, monitoring, and security features in line with best practices. Step 422 may fine-tune the GenAI model and prompt templates to handle unique scenarios within the environment, ensuring compatibility with custom connectors and specific use cases. In addition, custom connector alternatives may be developed using GenAI assistance. Step 424 may use GenAI tooling to convert Legacy APIs to modernized controllers. In addition, scripts and/or DevOps pipelines may be developed to manage the deployment of modernized APIs.

Step 426 may conduct thorough integration testing of custom connectors and libraries to validate functional and resiliency requirements. In addition, step 426 may conduct integration and user acceptance testing to validate the functional and resiliency requirements. This may be applied to ensure that the newly developed APIs conform to the defined service level objectives by conducting thorough testing. In addition, this may involve testing and validating DevOps pipelines and scripts.

Step 428 may represent a Go-Live step. This may involve: developing Go-live related runbooks; performing Go-live activities; identifying Handover/Knowledge Transfer activities and supporting Hypercare activities following Production deployment.

While the process of FIG. 4 illustrates certain steps performed in a particular order, it should be understood that the embodiments of the present invention may be practiced by adding one or more steps to the processes, omitting steps within the processes and/or altering the order in which one or more steps are performed.

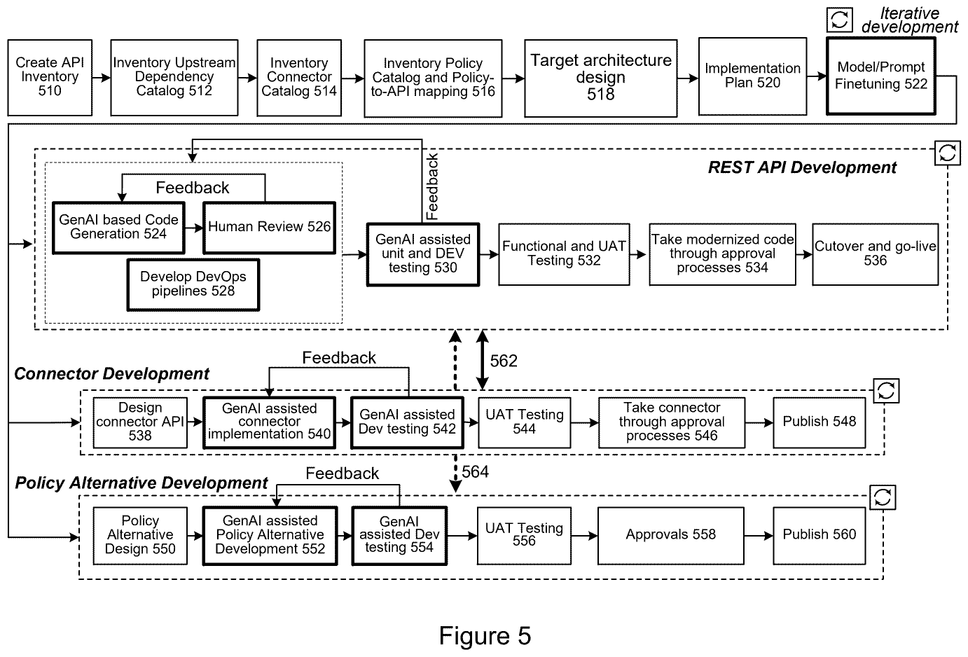

FIG. 5 is an exemplary flowchart, according to an embodiment of the present invention. At step 510, an API inventory may be created. At step 512, an inventory upstream dependency catalog may be identified. Dependencies may involve APIs, databases, etc. At step 514, an inventory connector catalog may be identified. At step 516, an inventory policy catalog and policy-to-API mapping may be identified. At step 518, a target architecture design may be developed. Architecture design may include secret/confidential configuration, observability, API management, etc. At step 520, an implementation plan may be developed. At step 522, a model/prompt may be fine-tuned through an iterative development process.

Development stages may be applied including REST API Development, Connector Development and Policy Alternative Development. The stages may be updated through an iterative development process. REST API may represent a type of API that follows representational state transfer (REST) architectural style or set of guidelines for how applications should interact with each other over a network.

REST API development may include a feedback process involving GenAI Based code generation 524 and Human Review 526 and DevOps Pipelines development 528. An additional feedback process may include GenAI assisted unit and development testing at 530. Functional and User Acceptance Testing (UAT) may be performed at step 532. The modernized code may go through an approval process at step 534. Cutover and go-live may occur at step 536.

Connector Development may involve design connector API at step 538. A feedback process may include GenAI assisted connector implementation 540 and GenAI assisted development testing 542. UAT testing may occur at 544. The connector may go through an approval process at step 546. A step to Publish may occur at 548.

Policy Alternative Development may involve policy alternative design at step 550. A feedback process may include GenAI assisted policy alternative development 552 and GenAI assisted development testing 554. UAT testing may occur at 556 and Approvals at 558. A step to Publish may occur 560.

As shown by 562, REST API implementation depends on connectors and connectors will need to be refactored as necessary to satisfy REST API requirements

As shown by 564, required policy alternatives need to be developed before REST APIs go-live.

While the process of FIG. 5 illustrates certain steps performed in a particular order, it should be understood that the embodiments of the present invention may be practiced by adding one or more steps to the processes, omitting steps within the processes and/or altering the order in which one or more steps are performed.

An embodiment of the present invention may be integrated with an Intelligent Modernization Toolkit that accelerates legacy technology modernization. This may involve accelerating modernization of legacy workloads to modern, maintainable code, customizable for various use cases and technologies. Features may include: logic extraction; code conversion; documentation; test data generation; agent based automated testing and remediation.

Benefits may include a reduction of risk and increase productivity and efficiency through technology debt reduction; streamlined code modernization process; improved code and documentation quality and test coverage and reduction in expenses, labor, development time and other resources.

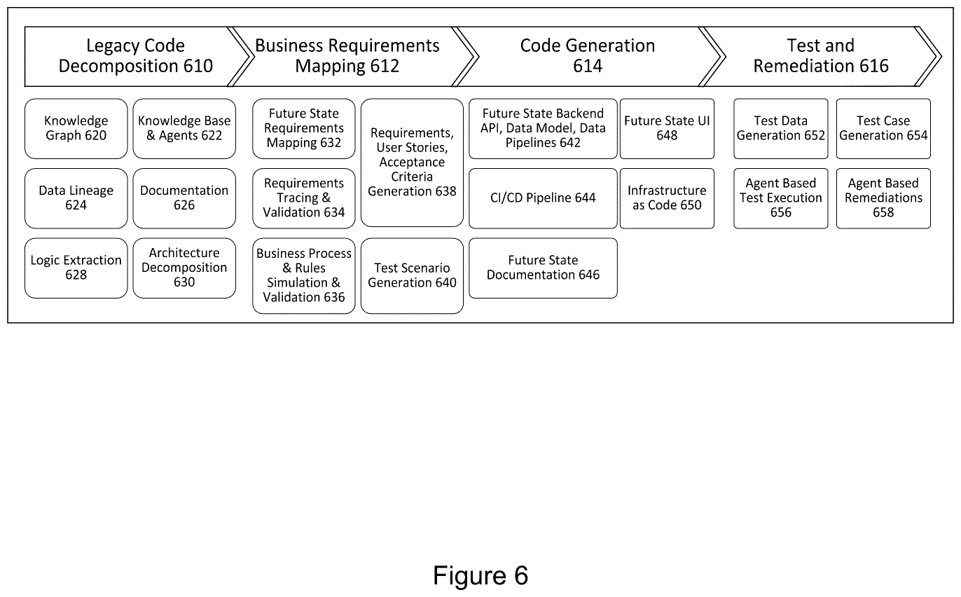

FIG. 6 is an exemplary diagram, according to an embodiment of the present invention. As shown in FIG. 6, intelligent modernization may include: Legacy Code Decomposition 610; Business Requirements Mapping 612; Code Generation 614 and Test and Remediation 616.

Legacy Code Decomposition 610 may involve: knowledge graph 620, knowledge base and agents 622, data lineage 624, documentation 626, logic extraction 628 and architecture decomposition 630.

Business Requirements Mapping 612 may involve: future state requirements mapping 632; requirements tracing and validation 634; business process and rules simulation and validation 636; requirements, user stories, acceptance criteria generation 638; and test scenario generation 640.

Code Generation 614 may involve: future state backend API, data model, data pipelines 642; CI/CD pipeline 644; future state documentation 646; future state UI 648, and infrastructure as a code 650.

Test and Remediation 616 may involve: test data generation 652; agent based test execution 656; test case generation 654 and agent based remediations 658.

An embodiment of the present invention is directed to a toolkit that may perform use case specific pre-processing of legacy code utilizing graph computations and other methodologies embedding expertise into pre-processing logic. The pre-processing logic allows knowledge/logic extraction from legacy code, rationalization of logic/flows, smart merging as well as decomposition where needed. The pre-processing logic may use advanced processing that embeds entity-specific expertise and use multi-level indexes including graph and vector indexes.

In addition, the toolkit may provide an ability for users to use this information as an interactive knowledge base. The toolkit may further support mapping extracted logic to a future state design utilizing an smart legacy code tracing mechanism. Future state code generation may be performed through a multi-agent framework. After the conversion, agentic tools may generate test cases and test data, execute the test cases and remediate any errors found in the generated code.

Intelligent modernization toolkit may apply to various use cases, applications, industries and scenarios. For example, modernization may apply to Integration Modernization; Data Pipeline and Database Modernization; SaS Model Modernization; Legacy Application Modernization and Mainframe Modernization.

Integration Modernization enables rapid modernization of application integration platforms.

Data Pipeline and Database Modernization involves modernizing the data pipelines and databases thereby accelerating data value realization. For example, Data Pipeline upgrade and conversion may involve: Datastage; Informatica, AbInitio, etc. Alteryx modernization and conversion may also be supported. For database modernization and data lineage mapping, additional pre-processing may be applied to optimize data and analytics flows. Additional pre-processing may be applied to the database structures, queries, stored procedures and functions to extract execution flows, column level data flow lineage and to extract business logic.

SAS Model Modernization reduces the cost of financial model risk management and improve business capabilities by leveraging newer platforms. For SAS Model Modernization, the toolkit of an embodiment of the present invention may perform additional post-processing of generated code utilizing Python project documentation to map a best matching library for the corresponding SAS capability. Other data and AI platforms may be supported.

Legacy Application Modernization involves modernizing legacy applications to reduce technology debt, licensing costs, new business capabilities and time to market improvements.

Mainframe Modernization reduces reliance on the mainframe thereby saving costs and unlocking new digital capabilities.

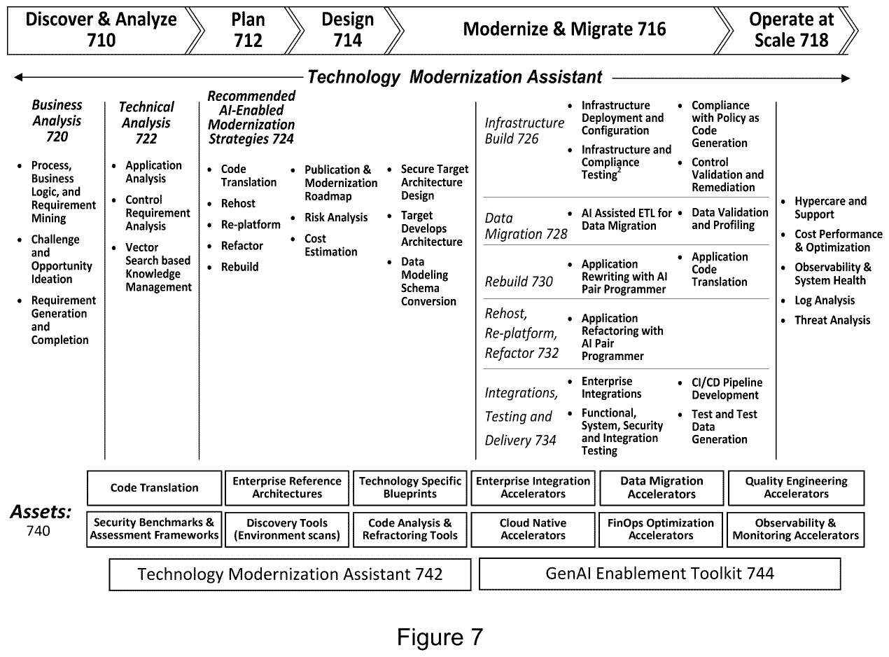

FIG. 7 is an exemplary diagram, according to an embodiment of the present invention. As shown in FIG. 7, various phases may be supported including Discovery and Analyze 710, Plan 712; Design 714; Modernize and Migrate 716, and Operate at Scale 718.

Discover and Analyze 710 may involve: Business Analysis 720 and Technical Analysis 722. Business Analysis 720 may include: process, business logic, and requirement mining; challenge and opportunity ideation and requirement generation and completion.

Technical Analysis 722 may include: application analysis, control requirement analysis and vector search based knowledge management.

Plan 712 may involve recommendation AI-enabled modernization strategies 724. This may include: code translation, rehost, re-platform, refactor and rebuild.

Design 714 may involve: publication and modernization roadmap, risk analysis, cost estimation.

Modernize and Migrate 716 may include: secure target architecture design, target develops architecture and data modeling schema conversion. In addition, Modernize and Migrate 716 may involve: infrastructure build 726; data migration 728; rebuild 730; rehost/re-platform/refactor 732 and integrations, testing and delivery 734.

Infrastructure build 726 may include: infrastructure deployment configuration; infrastructure and compliance testing, compliance with policy as code generation, and control validation and remediation. Data migration 728 may include: AI Assisted extract, transform and load (ETL) for data migration and data validation and profiling.

Rebuild 730 may involve: application rewriting with AI pair programmer and application code translation. Rehost/re-platform/refactor 732 may include: application refactoring with AI pair programmer. Integrations, testing and delivery 734 may involve: enterprise integrations, functional, system, security and integration testing, CI/CD pipeline development and test and test data generation.

Operate 718 may include: hypercare and support; cost performance and optimization; observability and system health; log analysis and threat analysis.

Assets 740 to accelerate the modernization process may include: code translation, enterprise reference architectures, technology specific blueprints, enterprise integration accelerators, data migration accelerators, quality engineering accelerators, security benchmarks and assessment frameworks, discovery tools (environment scans), code analysis and refactoring tools, cloud native accelerators, financial operations (FinOps) optimization accelerators, and observability and monitoring accelerators. Assets may leverage Technology Modernization Assistant 742 and GenAI Enablement Toolkit 744.

FIG. 8 illustrates a user interface, according to an embodiment of the present invention. User Interface 810 may provide Estimates and Forecasts 812, Source 814 and Target 816 with corresponding methods, functions, code, etc. Lines of code may be provided at 820. Activities 830 may provide details for specific pipelines and corresponding steps. User Interface 810 may correspond to 150 in FIG. 1.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the System software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

What is claimed is:

1. A computer-implemented system for implementing a GenAI code modernization and integration platform, the system comprising:
an input interface that communicates with one or more data pipelines;
a database that stores and manages data from the one or more data pipelines; and
a computer processor coupled to the input interface and the database and further programmed to perform the steps of:
creating an inventory of application programming interfaces for a legacy environment;
identifying one or more custom connectors to achieve parity with the inventory of application programming interfaces;
assessing a current state of observability to identify one or more gaps and enhancements needed;
defining a target architecture design for a deployment model wherein the deployment model relates to an API deployment with generative artificial intelligence (GenAI) based code generation, a connector deployment and a policy alternative deployment and wherein the deployment model applies a GenAI model with large language model (LLM) prompts for the one or more custom connectors;
applying the GenAI model to convert a set of legacy application programming interfaces to a set of modernized controllers;
developing scripts and pipelines to manage a deployment of the set of modernized controllers;
performing a set of tests to validate functional requirements, wherein the set of tests comprises integration testing and user acceptance testing; and
providing, via a user interface, a code translation and an activity status associated with the deployment.

2. The computer-implemented system of claim 1, wherein the inventory of application programming interfaces is based on a legacy code discovery relating to: workflows, integrations, legacy code, data models, scripts and data pipelines.

3. The computer-implemented system of claim 1, wherein the inventory of application programming interfaces comprises an index of code artifacts and documentation.

4. The computer-implemented system of claim 1, wherein the GenAI based code generation comprises human code reviews and a script and pipeline development.

5. The computer-implemented system of claim 1, wherein the target architecture design comprises configuration files, observability data, and API management.

6. The computer-implemented system of claim 1, wherein the deployment model comprises: a project template that follows best practices and connector alternative specifications.

7. The computer-implemented system of claim 1, wherein the deployment model addresses the one or more gaps and enhancements needed.

8. The computer-implemented system of claim 1, wherein the integration testing comprises ensuring the set of modernized controllers and application programming interfaces conform to one or more service level objectives.

9. The computer-implemented system of claim 1, wherein the activity status comprises pipeline run status.

10. The computer-implemented system of claim 1, wherein the inventory comprises: usage of a set of connectors, one or more service level objectives, one or more security requirements and specific capabilities.

11. A computer-implemented method for implementing a GenAI code modernization and integration platform, the method comprising the steps of:
creating, via an input interface, an inventory of application programming interfaces for a legacy environment;
identifying, via a computer processor, one or more custom connectors to achieve parity with the inventory of application programming interfaces;
assessing, via the computer processor, a current state of observability to identify one or more gaps and enhancements needed;
defining, via the computer processor, a target architecture design for a deployment model wherein the deployment model relates to an API deployment with generative artificial intelligence (GenAI) based code generation, a connector deployment and a policy alternative deployment and wherein the deployment model applies a GenAI model with large language model (LLM) prompts for the one or more custom connectors;
applying, via the computer processor, the GenAI model to convert a set of legacy application programming interfaces to a set of modernized controllers;
developing, via the computer processor, scripts and pipelines to manage a deployment of the set of modernized controllers;
performing, via the computer processor, a set of tests to validate functional requirements, wherein the set of tests comprises integration testing and user acceptance testing; and
providing, via a user interface, a code translation and an activity status associated with the deployment.

12. The computer-implemented method of claim 11, wherein the inventory of application programming interfaces is based on a legacy code discovery relating to: workflows, integrations, legacy code, data models, scripts and data pipelines.

13. The computer-implemented method of claim 11, wherein the inventory of application programming interfaces comprises an index of code artifacts and documentation.

14. The computer-implemented method of claim 11, wherein the GenAI based code generation comprises human code reviews and a script and pipeline development.

15. The computer-implemented method of claim 11, wherein the target architecture design comprises configuration files, observability data, and API management.

16. The computer-implemented method of claim 11, wherein the deployment model comprises: a project template that follows best practices and connector alternative specifications.

17. The computer-implemented method of claim 11, wherein the deployment model addresses the one or more gaps and enhancements needed.

18. The computer-implemented method of claim 11, wherein the integration testing comprises ensuring the set of modernized controllers and application programming interfaces conform to one or more service level objectives.

19. The computer-implemented method of claim 11, wherein the activity status comprises pipeline run status.

20. The computer-implemented method of claim 11, wherein the inventory comprises: usage of a set of connectors, one or more service level objectives, one or more security requirements and specific capabilities.
